(19) United States
(12) Patent Application Publication
(10) Pub. No.: US 2023/0201783 A1
(43) Pub. Date: Jun. 29, 2023

(54) PROCESSES FOR REDUCING SHUTDOWN TIME OF SUB-SYSTEMS IN LOW-DENSITY POLYETHYLENE PRODUCTION

(71) Applicant: ExxonMobil Chemical Patents Inc., Baytown, TX (US)

(72) Inventor: Cindy DEWITTE, Puurs-Sint-Amands (BE)

(21) Appl. No.: 17/999,183

(22) PCT Filed: May 18, 2021
(86) PCT No.: PCT/US2021/070572

§ 371 Date: Nov. 17, 2022

Related U.S. Application Data
(60) Provisional application No. 63/043,484, filed on Jun. 24, 2020.

(51) Int. Cl. B01J 3/04; B01J 4/00

(52) U.S. Cl. CPC B01J 3/042; B01J 4/008; B01J 2219/00162; B01J 2219/0027

(57) ABSTRACT

Processes for reducing shutdown time of a sub-system/ reactor component in an LDPE process. The process includes closing one or more pairs of upstream lock-out valves, each pair of upstream lock-out valves being located in an inlet stream upstream of the reactor component and configured to cease fluid flow into the reactor component through said inlet stream when said pair of upstream lock-out valves is closed; closing one or more pairs of downstream lock-out valves, each pair of downstream lock-out valves being located in an outlet stream downstream of the reactor component and configured to cease fluid flow out of the reactor component through said outlet stream when said pair of downstream lock-out valves is closed; depressurizing the reactor component; introducing purge gas comprising N₂ into the reactor component at and withdrawing the purge gas from the reactor component.

### CROSS REFERENCE TO RELATED APPLICATION

This application claims the benefit of U.S. Provisional Application 63/043484 filed Jun. 24, 2020, entitled “Processes For Reducing Shutdown Time Of Sub-Systems In Low-Density Polyethylene Production”, the entirety of which is incorporated by reference herein.

### FIELD

Embodiments of the present invention generally relate to low-density polyethylene production. More particularly, such embodiments relate to processes for reducing shutdown time of sub-systems in high pressure low-density polyethylene production.

### BACKGROUND

In high pressure low-density polyethylene (LDPE) production, compressed ethylene is introduced to a high pressure tubular or autoclave reactor to form LDPE. The unreacted off-gas and the LDPE product is then sent to a high pressure separator where the unreacted off-gas is removed and sent to a cooling recycle system. The cooled gas is then recycled to a secondary compressor upstream from the LDPE reactor. The LDPE product leaving the high pressure separator is further routed to a low pressure separator to separate the product from any remaining gas, and the gas that exits the low pressure separator is fed to a purge compressor before being recycled to a primary compressor upstream of the secondary compressor.

The different sub-systems of the LDPE production process such as the reactor, the compressors, and the cooling recycle system often need to be shut down to perform maintenance or cleaning or when a process upset occurs. Traditionally, when one sub-system needs to be shut down all of the other sub-systems need to be shut down as well. As such, all of the sub-systems are exposed to the atmosphere and thus to O₂ during shutdown. The presence of O₂ in various sub-systems such as the reactor and the separators can undesirably cause decomposition of the LDPE reaction product. This decomposition can lead to an unwanted increase in the temperatures and pressures of such sub-systems, which can result in further problems such as failure of a pipe. Consequently, these subsystems need to be shut down even longer. Other problems that occur during shut down include the loss of ethylene, co-monomer, and modifier i.e., the feed material, to the atmosphere as well as the release of volatile organic compounds (VOCs), e.g., ethylene feed impurities, to the atmosphere for systems not connected to a flare.

Since all of the sub-systems of the LDPE production process are exposed to the atmosphere during shut down, start-up of the sub-systems requires that all those systems be purged with N₂ repeatedly at near-atmospheric pressure to remove the unwanted O₂, followed by introducing ethylene to the sub-systems. This need to introduce ethylene to the sub-systems is not very cost effective. The amount of time required for the shutdown of each sub-system is thus compounded by the need to perform these steps prior to the start-up of each subsystem.

A need therefore exists to reduce the shutdown time of the LDPE production process. Reducing the amount of ethylene, co-monomer, and modifier lost and the amount of VOC emissions during shutdown is also highly desired.

### SUMMARY

Improved processes for shutting down one or more sub-systems of a high pressure LDPE production process are provided. In one or more embodiments, a process for shutting down a reactor component in a LDPE production process includes: closing one or more pairs of upstream lock-out valves, each pair of upstream lock-out valves being located in an inlet stream upstream of the reactor component and configured to cease fluid flow into the reactor component through said inlet stream when said pair of upstream lock-out valves is closed; closing one or more pairs of downstream lock-out valves, each pair of downstream lock-out valves being located in an outlet stream downstream of the reactor component and configured to cease fluid flow out of the reactor component through said outlet stream when said pair of downstream lock-out valves is closed; depressurizing the reactor component to a pressure greater than about 0 MPag and less than about 1.0 MPag; introducing purge gas comprising N₂ into the reactor component through a purge gas inlet at a pressure greater than about 0.5 MPag and less than about 5.0 MPag; and withdrawing the purge gas from the reactor component through a purge gas outlet, wherein withdrawing the purge gas comprises depressurizing the reactor component to a pressure greater than about 0 MPag and less than about 1.0 MPag.

In one or more embodiments, a process for shutting down a reactor and a collection vessel in a LDPE production process includes: closing a first pair of in-line valves in a first stream being introduced to a reactor, a second pair of in-line valves in a second stream disposed between a cooling recycle system and a collection vessel for collecting wax, and a third pair of in-line valves in a third stream exiting the collection vessel, wherein a fourth stream exits the reactor and enters a high pressure separator disposed upstream from the cooling recycle system, wherein a first in-line valve and a second in-line valve downstream from the first in-line valve are disposed in the fourth stream, and wherein a fifth stream connects the fourth stream between the first in-line valve and the second in-line valve to the collection vessel; closing the second in-line valve in the fourth stream; opening a first bleeder valve in a first bleeder stream that connects to the first stream between the first pair of in-line valves, a second bleeder valve in a second bleeder stream that connects to the second stream between the second pair of in-line valves, a third bleeder valve in a third bleeder stream that connects to the third stream between the third pair of in-line valves, and a purge valve in the fifth stream; depressurizing the reactor to a pressure greater than about 0 MPag and less than about 1.0 MPag; and introducing purge gas comprising N₂ at a pressure greater than about 0.5 MPag and less than about 5.0 MPag to the reactor.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a flow diagram of an illustrative high pressure low-density polyethylene (LDPE) production process, according to one or more embodiments described herein.

FIG. 2 depicts a front plan view of an illustrative pressure gauge that can be positioned in the LDPE production process from FIG. 1, according to one or more embodiments described herein.

FIG. 3 depicts a flow diagram of an illustrative high pressure LDPE production process that includes a bypass stream for sending reactant material to a cooling recycle system while bypassing a secondary compressor to allow concurrent cleaning of the cooling recycle system and maintenance of the secondary compressor, according to one or more embodiments described herein.

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

In the following discussion and in the claims, the terms “including” and “comprising” are used in an open-ended fashion, and thus should be interpreted to mean “including, but not limited to.” The phrase “consisting essentially of” means that the described/claimed composition does not include any other components that will materially alter its properties by is any more than 5% of that property, and in any case does not include any other component to a level greater than 3 mass %.

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an olefin” include embodiments where one, two, or more olefins are used, unless specified to the contrary or the context clearly indicates that only one olefin is used.

The term “wt %” means percentage by weight, “vol %” means percentage by volume, “mol %” means percentage by mole, “ppm” means parts per million, “ppm wt” and “wppm” are used interchangeably and mean parts per million on a weight basis, and “volppm” means parts per million on a volume basis. All concentrations herein, unless otherwise stated, are expressed on the basis of the total amount of the composition in question.

The term “α-olefin” refers to any linear or branched compound of carbon and hydrogen having at least one double bond between the α and β carbon atoms. For purposes of this specification and the claims appended thereto, when a polymer or copolymer is referred to as including an α-olefin, e.g., poly-α-olefin, the α-olefin present in such polymer or copolymer is the polymerized form of the α-olefin.

The term “polymer” refers to any two or more of the same or different repeating units/mer units or units. The term “homopolymer” refers to a polymer having units that are the same. The term “copolymer” refers to a polymer having two or more units that are different from each other, and includes terpolymers and the like. The term “terpolymer” refers to a polymer having three units that are different from each other. The term “different” as it refers to units indicates that the units differ from each other by at least one atom or are different isomerically. Likewise, the definition of polymer, as used herein, includes homopolymers, copolymers, and the like. By way of example, when a copolymer is said to have a “propylene” content of 10 wt % to 30 wt %, it is understood that the repeating unit/mer unit or simply unit in the copolymer is derived from propylene in the polymerization reaction and the derived units are present at 10 wt % to 30 wt %, based on a weight of the copolymer.

The term “in fluid communication” signifies that fluid can pass from a first component to a second component, either directly or via at least a third component. The term “inlet” refers to the point at which fluid enters a component, and the term “outlet” signifies the point at which fluid exits a component.

Nomenclature of elements and groups thereof used herein are pursuant to the Periodic Table used by the International Union of Pure and Applied Chemistry after 1988. An example of the Periodic Table is shown in the inner page of the front cover of Advanced Inorganic Chemistry, 6th Edition, by F. Albert Cotton et al. (John Wiley & Sons, Inc., 1999).

A detailed description will now be provided. Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

An improved process for shutting down one or more sub-systems of a high pressure LDPE production process is disclosed herein. A “high pressure” LDPE production process is a LDPE production process in which the polymerization is performed in a reactor at a pressure of 120 to 320 MPag. In this process, each sub-system that needs to be shut down can be isolated from every other sub-system by closing a pair of in-line valves disposed in streams being fed to as well as in streams exiting the sub-system. A bleeder stream that connects to each closed stream at a location between each pair of in-line valves can include a bleeder valve. This bleeder valve can be opened to release any gas leaking past either of the in-line valves. As used herein, the term “bleeder” is an adjective that indicates that something releases gas to a safe location such as a flare.

By isolating or compartmentalizing the sub-system that needs to be shut down, the other sub-systems can remain pressurized, ethylene can be stored in these sub-systems, and VOC emissions from these sub-systems can be eliminated or reduced during shutdown. Thus, there is usually no need to purge these other sub-systems with purge gas (e.g., N₂) (which would displace ethylene, co-monomer, and modifier, requiring replacement of such species prior to re-starting the shut-down sub-system), thereby reducing the overall shut-down time. In addition, this and other processes described herein can advantageously enable the use of higher purge gas initial pressures, dropped to lower final pressures. As discussed below, a greater initial to final pressure differential in purge gas flow-through can increase purging efficiency, thereby reducing the number of cycles of purge gas needed to accomplish a given clean-out, which again reduces shut-down time.

Each sub-system of the LDPE production process may also be referred to herein as a “reactor component”. In one or more embodiments, a process for shutting down a reactor component in a LDPE production process includes: closing one or more pairs of upstream lock-out valves, each pair of upstream lock-out valves being located in an inlet stream upstream of the reactor component and configured to cease fluid flow into the reactor component through said inlet stream when the pair of upstream lock-out valves is closed; closing one or more pairs of downstream lock-out valves, each pair of downstream lock-out valves being located in an outlet stream downstream of the reactor component and configured to cease fluid flow out of the reactor component through the outlet stream when the pair of downstream lock-out valves is closed; depressurizing the reactor component to a pressure greater than about 0 MPag and less than about 1.0 MPag; introducing purge gas (which preferably comprises or consists essentially of N₂) into the reactor component through a purge gas inlet at a pressure lower than the design pressure of the reactor component, preferably at a pressure greater than about 0.5 MPag and less than about 5.0 MPag, more preferably at a pressure greater than about 0.5 MPag and less than about 3.5 MPag; and withdrawing the purge gas from the reactor component through a purge gas outlet by depressurizing the reactor component to a pressure greater than about 0 MPag and less than about 1.0 MPag.

As just noted, purge gas preferably includes N₂, although the ordinarily skilled artisan will appreciate that any non-reactive gas (e.g., Ar or other noble gases) may be used. Thus, although many discussions of particular embodiments herein reference nitrogen or N₂, it will be appreciated that such other purge gas or gases may also or instead be utilized. Finally, as the ordinarily skilled artisan will also realize, trace impurities (e.g., less than 10 ppm total) may be present in the purge gas; thus, when a purge gas is said to “consist essentially of” nitrogen or another species, that is intended to allow for the presence of such trace impurities.

Shut down of a sub-system can occur for a number of reasons such as equipment maintenance or cleaning or after the evacuation of the sub-system contents following a process interruption, wherein said evacuation process is disclosed in International Publication No. WO2020/102388, the entire contents of which are incorporated by reference herein. The depressurization and purging of the isolated sub-system with N₂ can be repeated until the concentration of O₂ present in the sub-system is less than 10, 15, or 20 volppm (preferably less than 10 ppm) since air might enter the sub-system sometime during shutdown. Thus, undesirable reactions with O₂ can be eliminated and no decomposition reaction can take place. Since the sub-system is purged with N₂ at a relatively high pressure and thus high density, less depressurization and purging cycles are needed, which advantageously reduces the overall shutdown time. The higher the pressure of the N₂ introduced for purging, the lower the number of depressurization and purging cycles needed. Preferably, remaining N₂ is allowed to remain in the shut-down sub-system after the final purging to reduce unit shutdown time; such remainder typically will not cause adverse effects after starting back up and therefore is a suitable approach to further increasing efficiency of the shut-down process. Moreover, according to various embodiments, the shut-down and purging process provided above can be automated using sequence control.

As an example, the purging process outlined above can be carried out by first introducing N₂ to the sub-system or reactor component at an initial pressure within a range from a low end of 0.5 MPag (such as any one of 0.5, 0.6, 0.7, 0.8, 0.9, 1.0, 1.5, 2.0, 2.5, 3.0, 3.5, 4.0, 4.5, 4.6, 4.7, 4.8. 4.9 MPag) to a high end of 5.0 MPag (such as any one of 5.0, 4.9, 4.8, 4.7, 4.6, 4.5, 4.4, 4.3, 4.2, 4.1, 4.0, 3.5, 3.0, 2.5, 2.0, 1.5, and 1.0 MPag), provided the high end of the range is greater than the low end. Thus, for example, the initial pressure may be within the range from 3.5 to 5.0 MPag, such as from 4.0 or 4.5 to 5.0 MPag. The sub-system can then be depressurized to a final pressure that is lower than the initial pressure. According to various embodiments, the final pressure can be greater than 0 MPag and less than 1.0 MPag (e.g., within the range from a low of 0.01, 0.02, 0.05, 0.1, 0.2, 0.3, 0.4, 0.5, 0.6, 0.7 or 0.8 MPag to a high of 0.02, 0.05, 0.1, 0.2, 0.3, 0.4, 0.5, 0.6, 0.7, 0.8, 0.9, 0.95, or 0.99 MPag, provided the high end of the range is greater than the low end). The depressurization and purging with N₂ can be repeated until the concentration of O₂ present in the sub-system is less than about 10 volppm. This process also can be automated using sequence control.

The shut-down time of each sub-system can further be reduced by placing a low range temporary pressure gauge in fluid communication with the sub-system for more accurate monitoring of the pressure of the sub-system, therefore allowing depressurization to a lower pressure during system purging with N₂. Thus, even less purging cycles and time are required to purge the subsystem. The pressure gauge can include an over-range protector that prohibits overpressure of the pressure gauge.

The shut-down time of each sub-system can also be decreased by placing a quick change blind in the N₂ supply streams which are in fluid communication with the sub-systems of the LDPE production process. The quick change blind can be quickly slid from a closed position to an open position to allow N₂ to flow therethrough. As a result, the time required to initiate purging of a sub-system with N₂ can be significantly reduced.

Another way to reduce the shut-down time of the LDPE production process can be to perform cleaning of one sub-system concurrent with performing maintenance of another sub-system, which would require less time than if the cleaning and the maintenance were performed at different times. For example, the cooling recycle system periodically needs to be cleaned due to fouling that occurs in the heat exchangers of the system. A bypass conduit can be installed that connects the feed stream entering the secondary compressor to the cooling recycle system. Instead of sending the feed stream to the secondary compressor from the primary compressor, the feed stream can thus be re-directed to the cooling recycle system to allow for simultaneous shut down of the secondary compressor and cleaning of the cooling recycle system.

Rather than shutting down each sub-system individually, two or more sub-systems or reactor components in series could also be shut down simultaneously. In one or more embodiments, multiple reactor components in series can be purged with N₂ by closing each pair of upstream lock-out valves located upstream of the upstream-most component being purged, closing each pair of downstream lock-out valves located downstream of the downstream-most component being purged, and leaving open all pairs of lock-out valves located between the upstream most component being purged and the downstream most component being purged. As such, all components in series can he captured in a purge in a manner analogous to how a single component between closed valve pairs is captured in a purge. N₂ can be introduced by the upstream-most valve (i.e., upstream of the first series reactor component) and can exit via the downstream-most valve (i.e., downstream of the last series reactor component), This purging of multiple components advantageously enables sweep-through purging by allowing N₂ to flow through pipes connecting the reactor components and purging any O₂ or other material found therein,

### LDPE Production Process

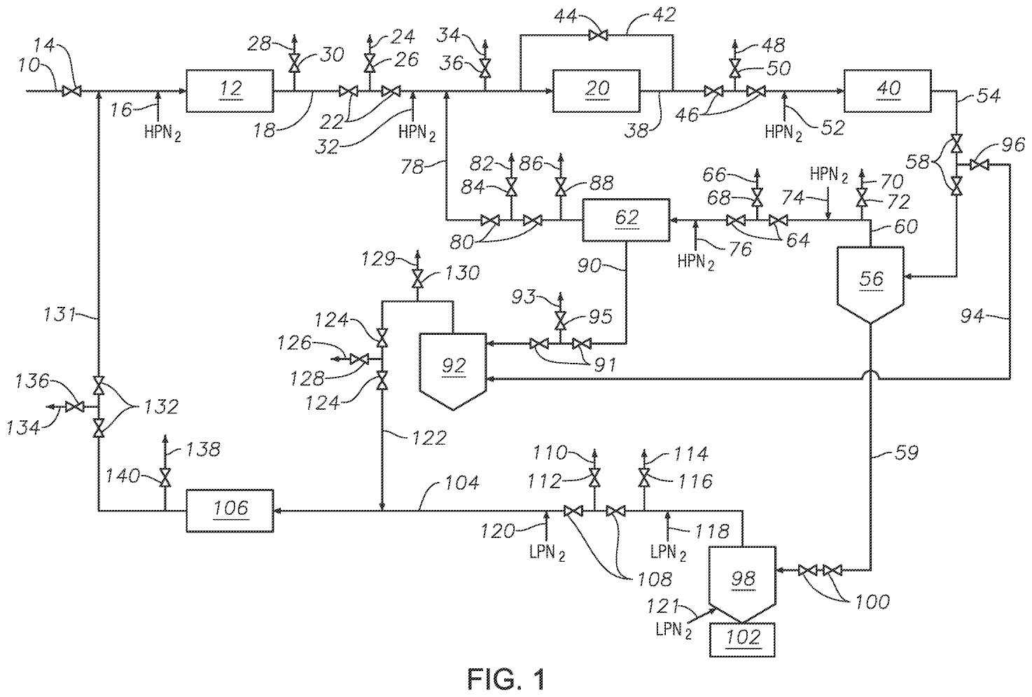

Turning to FIG. 1, a flow diagram of an exemplary high pressure LDPE production process is depicted which can be equipped with the means for reducing the time required to shut down each sub-system of the LDPE production process. As shown, a feed stream 10 can first be introduced to a primary compressor 12 to raise the pressure of the feed stream 10. A feed valve 14 can be disposed in feed stream 10 for controlling flow therethrough, and a N₂ supply stream 16 can be introduced to the feed stream 10 for purging the primary compressor 12 when desired. The feed stream 10 can include raw material typically employed in a polymerization process to produce LDPE. For example, the feed stream 10 can include is ethylene or ethylene mixed with at least one other comonomer if it is desirable to produce polyethylene copolymers. Alternatively, the feed stream 10 could include ethylene, and at least one other comonomer could be introduced to a compressed feed stream 18 leaving primary compressor 12.

Examples of suitable comonomers include: vinyl ethers such as vinyl methyl ether and vinyl ether; olefins such as propylene, 1-butene, 1-octene, and styrene; vinyl esters such as vinyl acetate, vinyl butyrate, and vinyl pivalate: haloolefins such as vinyl fluoride and vinylidene fluoride; acrylic esters such as methyl acrylate, ethyl acrylate, butyl acrylate, and methacrylates; other acylic or methacrylic compounds such as acrylic acid, methacrylic acid, maleic acid, acrylonitrile, and acrylamide; and other compounds such as allyl alcohol, vinyl silanes, and other copolymerizable vinyl compounds. Two or more comonomers can be used, if desired. The olefin comonomer can be linear (e.g., linear C3 C20 olefins) or branched (e.g., olefins having one or more C1 C3 alkyl branches or an aryl group). Specific examples of olefins include C3 C12 olefins such as propylene; 1-butene; 3 methyl 1 butene; 3,3 dimethyl 1 butene; 1 pentene; 1 pentene with one or more methyl, ethyl, or propyl substituents; 1 hexene with one or more methyl, ethyl, or propyl substituents; 1 heptene with one or more methyl, ethyl, or propyl substituents; 1 octene with one or more methyl, ethyl or propyl substituents; 1 nonene with one or more methyl, ethyl or propyl substituents; ethyl, methyl, or dimethyl substituted 1 decene; 1 dodecene; and styrene.

The compressed feed stream 18 that exits primary compressor 12 can be introduced to a secondary compressor 20 to further increase its pressure. A pair of in-line valves 22 can be disposed in the feed stream 18, and a bleeder stream 24 that includes a bleeder valve 26 can connect to the feed stream 18 at a location between the in-line valves 22. While a N₂ supply stream 16 is shown as being connected to the feed stream 10 downstream of the feed valve 14, the N₂ supply stream 16 could be connected anywhere between the feed valve 14 and the in-line valves 22. Also, a vent stream 28 containing a vent valve 30 is depicted as being connected to the compressed feed stream 18 upstream of the in-line valves 22, but the vent stream 28 could be connected at any point between the feed valve 14 and the in-line valves 22. The vent valve/stream could vent to atmosphere or to flare; in some embodiments, then, the vent stream 28 could include a further valve downstream of the vent valve 30 (not shown) to enable the stream to pass to either flare or atmosphere, depending on the constituents being passed through the vent stream 28. A by-pass stream 42 going around the secondary compressor 20 can connect the input to the output of the secondary compressor 20. The by-pass stream 42 can include a by-pass valve 44.

A highly compressed feed stream 38 that exits secondary compressor 20 can next be introduced to a reactor 40 such as a tubular reactor or an autoclave reactor. A pair of in-line valves 46 can be positioned in the highly compressed feed stream 38, and a bleeder stream 48 containing a bleeder valve 50 can be connected to the feed stream 38 between the in-line valves 46.

The LDPE polymer or copolymer can be produced within reactor 40 using a high pressure and high temperature polymerization process. Various process variations that achieve safe and economical operating conditions are known in the art. By way of example, the polymerization process can be performed at a pressure of about 120 MPa to about 210 MPa and a temperature of about 148° C. to about 270° C. when a single autoclave reactor is used. It is to be understood that multiple reactors could be used instead. The polymerization reaction can be enhanced by the injection of at least one modifier or chain transfer agent. The modifier can be injected upstream of the primary compressor, but it can alternatively be injected upstream of the secondary compressor or upstream of the reactor. Examples of suitable modifiers include isobutylene, propylene, n-butane, hexane, propane, 1-butene, and aldehydes such as acetaldehyde and propionaldehyde.

An effluent stream 54 containing LDPE polymer or copolymer and unreacted ethylene, comonomer, and/or modifier can exit reactor 40. A pair of in-line valves 58 can be disposed in the effluent stream 54. The effluent stream 54 can be introduced to a high pressure separator 56 after undergoing a pressure drop in the in-line valves 58. Optionally, a purge gas (e.g., N₂ ) supply stream (not shown) and a vent stream having a vent valve (not shown) can be placed in fluid communication with the reactor 40 via connection to the highly compressed stream 38 or the effluent stream 54.

The high pressure separator 56 can split the effluent stream 54 into a polymer rich liquid phase 59 and an unreacted gas phase 60. As defined herein, a “high pressure” separator is a separator that is operated at a pressure of about 20 MPag to about 30 MPag. The unreacted gas stream 60 that exits the high pressure separator 56 can be introduced to a cooling recycle system 62 having one or more heat exchangers, e.g., shell and tube heat exchangers, for cooling the unreacted gas with a cooling medium such as water. After the unreacted gas is cooled in the cooling recycle system 62, it can be recycled to the compressed feed stream 18 via cooled gas stream 78. In this manner, unreacted ethylene, comonomer, and/or modifier can be reintroduced to the secondary compressor 20, which is in fluid communication with the LDPE reactor 40. A pair of in-line valves 64 can be positioned in the unreacted gas stream 60, and a bleeder stream 66 having a bleeder valve 68 disposed therein can be connected to the unreacted gas stream 60 between the in-line valves 64. Another pair of in-line valves 80 can be disposed in the cooled gas stream 78, and a bleeder stream 82 containing a bleeder valve 84 can be connected to the stream 78 between the in-line valves 80. A vent stream 70 containing a vent valve 72 can also be connected to the unreacted gas stream 60 as shown, or it could be connected to the effluent stream 54 between the high pressure separator 56 and the in-line valves 58. As with vent stream 28 and vent valve 30, the vent stream 70 could include a further valve downstream of the vent valve 72 (not shown) to enable the stream to pass to either flare or atmosphere, depending on the constituents being passed through the vent stream 70. As depicted, N₂ supply streams 74 and 76 can be connected to the unreacted gas stream 60 on opposite sides of the in-line valves 64. However, the N₂ supply stream 74 could also be located upstream of the high pressure separator 56 and downstream from the in-line valves 58. Further, the N₂ supply stream 76 could also be located at any location downstream the in-line valves 64 and upstream from the in-line valves 80 . Yet another vent stream 86 containing a vent valve 88 can also be placed in fluid communication with the cooling recycle system 62 via connection anywhere between in-line valves 64, in-line valves 80, and in-line valves 91 (see below).

Wax entrained in the unreacted gas passing through the cooling recycle system 62 can flow down to a wax collection vessel 92, also known as a “wax blowdown drum” via stream 90. A pair of in-line valves 91 can be disposed in the stream 90, and a bleeder stream 93 containing a bleeder valve 95 can be connected to the stream 90. Another stream 94, which is connected to the effluent stream 54 leaving reactor 40, can be introduced to the collection vessel 92. This stream 94 can be connected to the effluent stream 54 between the in-line valves 58 and can include another valve 96, which can be called a “purge valve” since stream 94 can provide for easy purging of the reactor 40 and wax collection vessel 92 when valve 96 is opened.

The polymer rich liquid stream 59 that exits the bottom of the high pressure separator 56 can be directed to a low pressure separator 98. As defined herein, a “low pressure” separator is a separator that is operated at a pressure of about 0.01 MPag to about 0.3 MPag. Polymer that is allowed to collect in the bottom of the low pressure separator 98 can be sent to an extruder 102 to pelletize the polymer if desired. An unreacted gas stream 104 that exits the low pressure separator 98 can be sent to a recycle purge compressor 106 to increase the pressure of the stream 104 to that of the feed stream 10. Any gas that accumulates in the collection vessel 92 can be sent to the unreacted gas stream 104 via gas stream 122 to allow the gas to be fed to the purge compressor 106. A compressed gas stream 131 that exits the purge compressor 106 can then be recycled to the feed stream 10.

A pair of in-line valves 100 can be positioned in the polymer rich liquid stream 59 upstream from the low pressure separator 98. Another pair of in-line valves 108 can be disposed in the unreacted gas stream 104, and a bleeder stream 110 containing a bleeder valve 112 can be connected to the unreacted gas stream 104 anywhere between the in-line valves 108. Yet another pair of in-line valves 124 can be disposed in the gas stream 122, and another bleeder stream 126 containing a bleeder valve 128 can be connected the gas stream 122 between the in-line valves 124. A pair of in-line valves 132 also can be disposed in the recycled gas stream 131, and a bleeder stream 134 containing a bleeder valve 136 can be connected to the recycled gas stream 131 between the in-line valves 132. A vent stream 114 containing a vent valve 116 and a N₂ supply stream 118 both can be connected to the flow anywhere between in-line valves 108 and in-line valves 100. A N₂ supply stream 121 also can be introduced directly to the low pressure separator 98. A vent stream 138 containing a vent valve 140 and a N₂ supply stream 120 can be placed in fluid communication with the purge compressor 106 by connection anywhere upstream of in-line valves 132, downstream of in-line valves 124, and downstream of in-line valves 108. Another vent stream 129 containing a vent valve 130 can connect to the gas stream 122 between the in-line valves 124 and the collection vessel 92 as shown, or the vent stream could connect to the purge stream 94 downstream of the valve 96.

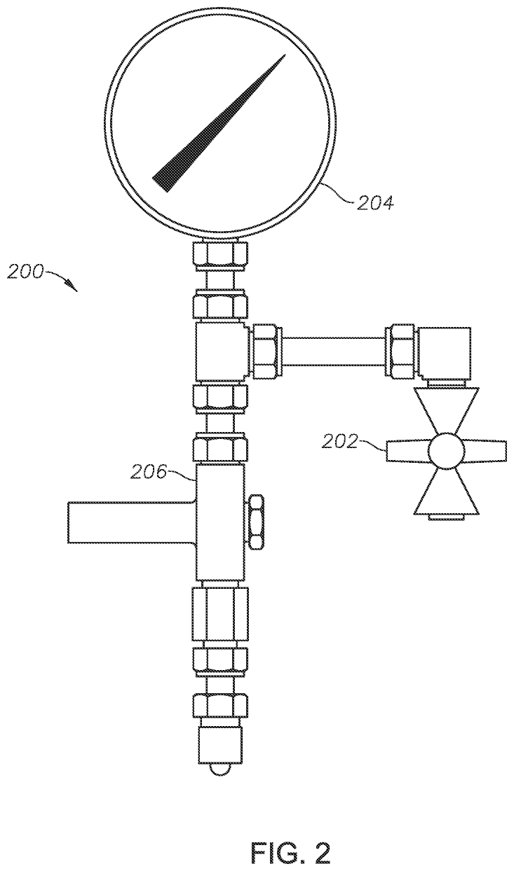

A pressure gauge 200 like that shown in FIG. 2 can be placed at any location between in-line valves (e.g., between an upstream pair of lock-out valves and a downstream pair of lock-out valves, where “upstream” and “downstream” are used in this context for relative reference with respect to any given reactor component or sub-system) in FIG. 1 when it is desirable to depressurize a sub-system of the LDPE production process, thereby releasing reactant material such as ethylene from the sub-system. The pressure gauge 200 can help ensure that the sub-system being depressurized during purging is vented to a relatively low pressure close to but above ambient pressure, for example greater than about 0 MPag and less than about 0.01, 0.02, 0.05, 0.1, 0.2, 0.3, 0.4, 0.5, 0.6, 0.7, 0.8, 0.9, or 1.0 MPag, thus inhibiting the ingress of O₂ into the sub-system from the atmosphere. As such, the number of depressurization/purge cycles typically needed to achieve a low O₂ concentration in the sub-system can be reduced. The pressure gauge 200 can include a manometer 204 that can be connected to a conduit or reactor component within the reactor system (for example, the associated vent stream or any other conduit in fluid communication with the reactor component such that the portion of the conduit to which the manometer 204 and hence pressure gauge 200 is connected will be pressurized during the lock-out purging process). The pressure gauge 200 also can include a needle valve 202 and an over-range protector 206 to ensure that the pressure does not exceed a certain amount. One example of a suitable over-range protector is the AORP model commercially available from Baumer ElectricAG in Frauenfeld, Switzlerland, which is designed to close when the pressure reaches a set amount between about 0.3 MPa and about 40 MPa. Another example of a suitable over-range protector is the AORPB model also commercially available from Baumer ElectricAG, which is designed to close when the pressure reaches a set amount between about 0.01 MPa and about 1.6 MPa.

In addition, a quick change blind can be positioned in each of the N₂ supply streams depicted in FIG. 1 to allow for faster release of N₂ when it is desirable to purge a sub-system of the LDPE production process. An example of a suitable quick change blind is the Quick-Action Line Blind commercially available from ONIS in France,

Each sub-system of the LDPE production process can be shut down in isolation as described below while keeping the other sub-systems pressurized and full of reactant material such as ethylene.

### Primary Compressor Shutdown Process

In one or more embodiments, shut down of the primary compressor 12 as a reactor component or sub-system is now described. Shut-down of the primary compressor 12 can be performed by closing the feed valve 14 in feed stream 10, the pair of in-line valves 22 in stream 18 (in this instance, such in-line valves 22 are considered a pair of upstream lock-out valves with respect to the primary compressor 12), and the pair of in-line valves 132 in stream 131 (in this case, such in-line valves 132 are considered a pair of downstream lock-out valves with respect to the primary compressor 12), and opening the upstream and downstream bleeder valves 26 and 136 (referring to FIG. 1). Then the primary compressor 12 can be depressurized by opening the vent valve 30 in the vent stream 28. This depressurization step effectively removes gas from the primary compressor 12. The vent stream 28 can go to flare or atmosphere, depending on the gas contents being vented; thus, in particular embodiments, the vent stream 28 may further include a valve to direct flow to either atmosphere or flare so that either can be selected depending upon the vent operation being carried out. It should be appreciated that any other vent stream described in connection with FIG. 1 (or with any process in general) can similarly be configured to vent to either atmosphere or flare, selectively even if such selective optionality is not depicted in FIG. 1.

Further, a low range pressure gauge like that shown in FIG. 2 can be placed in fluid communication with the primary compressor 12 (e.g., in vent stream 28, N₂ inlet stream 16, along the conduit of stream 18, along the compressor 12, or the like) to allow accurate pressure reading, and the vent valve 30 can be closed. Placing a pressure gauge in fluid communication can involve installing the gauge, or opening a valve, blind, or the like in order to place the gauge in fluid communication with the reactor component of interest (here, the primary compressor 12). N₂ can then be introduced to the primary compressor 12 by unlocking and sliding the quick change blind disposed in N₂ stream 16 to an open position, followed by locking the quick change blind in the open position. In this manner, the primary compressor 12 can be purged with N₂. It is to be understood that the quick change blind could be replaced with other types of valves; however, the use of the quick change blind advantageously reduces the time required to purge with N₂.

After performing maintenance on the primary compressor 12, the depressurization and N₂ purging steps can be repeated until a concentration of O₂ present in the primary compressor 12 is less than about 10 volppm, such as less than 9, 8, 7, 6, or 5 volppm. The N₂ can be allowed to remain in the primary compressor 12 after the final purging step. These steps can be automated using sequence control.

### Secondary Compressor Shutdown Process

In one or more embodiments, shut down of the secondary compressor 20 can be performed by closing the pair of in-line valves 22 in stream 18, the pair of in-line valves 46 in stream 38, the pair of in-line valves 80 in stream 78. In this example, the pair of in-line valves 22 and pair of in-line valves 80 are both examples of upstream pairs of lock-out valves; thus in embodiments according to this example, shut-down and purging of the secondary compressor 20 as a reactor component involves closing two pairs of upstream lock-out valves (22 and 80), each disposed along the two inlet streams 18 and 78 to secondary compressor 20. On the other hand, the pair of in-line valves 46 is the downstream pair of lock-out valves. In some embodiments, as shown in FIG. 1, a bypass stream 42 may also provide an optional route around the secondary compressor 20. The by-pass valve 44 in the by-pass stream 42 and the bleeder valves 26, 50, and 84 can also be opened (e.g., to ensure that purge gas will also flow through such bypass stream conduit). Then the secondary compressor 20 can be depressurized by opening the vent valve 36 in the vent stream 34. This depressurization step effectively removes gas from the secondary compressor 20. As noted with respect to vent stream 28, this vent stream 34 can be configured in various embodiments to vent selectively to flare or atmosphere.

Further, a low range pressure gauge like that shown in FIG. 2 can be placed in fluid communication with the secondary compressor 20 (e.g., in vent stream 34 or another conduit in fluid communication with the secondary compressor 20, such as along stream 38) to allow accurate pressure reading. Then N₂ can be introduced to the secondary compressor 20 by unlocking and sliding the quick change blind disposed in N₂ stream 32 to an open position, followed by locking the quick change blind in the open position. In this manner, the secondary compressor 20 can be purged with N₂. It is to be understood that the quick change blind could be replaced with other types of valves; however, the use of the quick change blind advantageously reduces the time required to purge with N₂.

After performing maintenance on the secondary compressor 20, the depressurization and N₂ purging steps can be repeated until a concentration of O₂ present in the secondary compressor 20 is less than about 10 volppm, such as less than 9, 8, 7, 6, or 5 volppm. The N₂ can be allowed to remain in the secondary compressor 20 after the final purging step, as similarly noted with respect to the primary compressor above. Furthermore, as also noted with respect to the primary compressor above, these steps can be automated using a sequence control.

### Reactor and Collection Vessel Shutdown Process

In an embodiment, the reactor 40 and the collection vessel 92 can be concurrently shut down and purged, in an example of purging two reactor components in series. According to various embodiments, the process may be carried out by first closing the pair of in-line valves 46 in stream 38, the second in-line valve 58 which is closest to the high pressure separator 56, the pair of in-line valves 91 in stream 90, and the pair of in-line valves 124 in stream 122. Closing the second in-line valve 58 eliminates the outlet stream split from reactor 40 to (1) high pressure separator 56 and (2) collection vessel 92, enabling treatment of the reactor 40 and collection vessel 92 consistently with in-series lock-out of both of these reactor components. In this instance, in embodiments in accordance with FIG. 1, there are two inlet streams to the sub-system comprising both reactor components reactor 40 and collection vessel 92: (1) inlet stream 38 to reactor 40 and (2) inlet stream 90 to collection vessel 92. And, following shut-off of the second in-line valve 58, there is an intermediate stream 54-to-94 from reactor 40 to collection vessel 92. Finally, there is outlet stream 122, with inline valves 124 acting as the downstream pair of lock-out valves. The bleeder valve 50, the purge valve 96, the bleeder valve 95, and the bleeder valve 128 can also be opened. The first in-line valve 58 which is closest to the reactor 40 can remain in the open position. Then the reactor 40 and the collection to vessel 92 can be depressurized by opening the vent valve 130 in the vent stream 129. This depressurization step effectively removes gas from the reactor 40 and the collection vessel 92. As noted with respect to other vent streams, this vent stream 129 can be configured in various embodiments to vent selectively to flare or atmosphere.

Further, a low range pressure gauge like that shown in FIG. 2 can be placed in fluid communication with the reactor 40 and the collection vessel 92 (e.g., in vent stream 129) to allow accurate pressure reading. Then N₂ can be introduced to the reactor 40 by unlocking and sliding the quick change blind disposed in N₂ stream 52 to an open position, followed by locking the quick change blind in the open position. In this manner, the reactor 40 can be purged with N₂. It is to be understood that the quick change blind could be replaced with other types of valves; however, the use of the quick change blind advantageously reduces the time required to purge with N₂.

After performing maintenance on the reactor 40, the depressurization and N₂ purging steps can be repeated until a concentration of O₂ present in the reactor 40 is less than about 10 volppm, such as less than 9, 8, 7, 6, or 5 volppm. As similarly described above with respect to other reactor components, the N₂ can be allowed to remain in the reactor 40 after the final purging step; and any or all of these shut-down and purge steps can be automated using a sequence control.

In an alternative embodiment, the purge stream 94 can be replaced by a bleeder stream 94 (not shown in FIG. 1) that is not directed to the collection vessel 92, but is instead directed somewhere else such as a flare or to atmosphere. In this case, shutdown of the reactor 40 and shutdown of the collection vessel 92 can be performed independently, as similarly described for any other reactor component (e.g., closing upstream lock-out valves 46 and downstream lock-out valves 58). The LDPE production process schematic according to some embodiments could further include an additional vent stream containing a vent valve (not shown in FIG. 1) that is in fluid communication with the reactor when it is desirable to independently shut down the reactor 40. Such a vent valve could, for instance, be located along stream 54 between the reactor 40 and the pair of inline valves 58 (which in such embodiments could serve as the downstream pair of lockout valves with respect to the reactor, with valve 96 serving as the bleeder valve for the inline valves 58). As noted with respect to other vent streams, this stream can be configured to selectively vent to either atmosphere or flare.

### High Pressure Separator Shutdown Process

In one or more embodiments, shut-down and purging of the high pressure separator 56 can be performed by closing the pair of in-line valves 58 in stream 54, the pair of in-line valves 64 in stream 60, and the pair of in-line valves 100 in stream 59. In this instance, inline valve pairs 64 and 100 serve as downstream lock-out valve pairs; and in-line valves 58 serve as upstream lock-out valve pairs, with respect to the high pressure separator 56. The bleeder valves 68 and 96 in bleeder stream 66 and 94, respectively, can also be opened. Next, the high pressure separator 56 can be depressurized by opening the vent valve 72 in the vent stream 70. This depressurization step effectively removes gas from the high pressure separator 56.

Further, a low range pressure gauge like that shown in FIG. 2 can be placed in fluid communication with the high pressure separator 56 to allow accurate pressure reading. Then N₂ can be introduced to the high pressure separator 56 by unlocking and sliding the quick change blind disposed in N₂ stream 74 to an open position, followed by locking the quick change blind in the open position. In this manner, the high pressure separator 56 can be purged with N₂. It is to be understood that the quick change blind could be replaced with other types of valves; however, the use of the quick change blind advantageously reduces the time required to purge with N₂.

After performing maintenance on the high pressure separator 56, the depressurization and N₂ purging steps can be repeated until a concentration of O₂ present in the high pressure separator 56 is less than about 10 volppm, such as less than 9, 8, 7, 6, or 5 volppm. The N₂ can be allowed to remain in the high pressure separator 56 after the final purging step. These steps can be automated using a sequence control.

### Cooling Recycle System Shutdown Process

In one or more embodiments, shut down of the cooling recycle system 62 can be performed by closing the pair of in-line valves 64 in stream 60, the pair of in-line valves 80 in stream 78, and the pair of in-line valves 91 in stream 90. In this instance, the in-line valves 64 are the upstream pair of lock-out valves; and the in-line valve pairs 80 and 91 are downstream lock-out valve pairs. The bleeder valves 68, 84, and 95 can also be opened. Next, the cooling recycle system 62 can be depressurized by opening the vent valve 88 in the vent stream 86. This depressurization step effectively removes gas from the cooling recycle system 62. As with other vent streams, this vent stream 86 may be configured to vent selectively to either flare or atmosphere.

Further, a low range pressure gauge like that shown in FIG. 2 can be placed in fluid communication with the cooling recycle system 62 to allow accurate pressure reading. Then N₂ can be introduced to the cooling recycle system 62 by unlocking and sliding the quick change blind disposed in N₂ stream 76 to an open position, followed by locking the quick change blind in the open position. In this manner, the cooling recycle system 62 can be purged to with N₂. It is to be understood that the quick change blind could be replaced with other types of valves; however, the use of the quick change blind advantageously reduces the time required to purge with N₂.

After performing maintenance on the cooling recycle system 62, the depressurization and N₂ purging steps can be repeated until a concentration of O₂ present in the cooling recycle is system 62 is less than about 10 volppm, such as less than 9, 8, 7, 6, or 5 volppm. As with other reactor components, the N₂ can be allowed to remain in the cooling recycle system 62 after the final purging step; and/or these steps can be automated using a sequence control.

### Low Pressure Separator Shutdown Process

In one or more embodiments, shut down of the low pressure separator 98 can be performed by closing the pair of in-line valves 100 in stream 59 and the pair of in-line valves 108 in stream 104. Here, the in-line valves 100 are the upstream pair of lock-out valves; and the in-line valves 108 are the downstream pair of lock-out valves. The bleeder valve 112 can also be opened. In some embodiments, an optional bleeder valve (not shown in FIG. 1) may also be included between in-line valves 100 which can be opened, however, in the particular case of this reactor component (low pressure separator 98), systems and processes according to some embodiments may omit the bleeder valve between the in-line valves 100 due to plugging risk in polymer service at this particular location. Indeed, the polymer flowing through the low pressure separator 98 can act as a barrier to block the flow of gas to the outlet of extruder 102. Optionally, however, a valve (not shown in FIG. 1) can be installed in the stream exiting the bottom of the low pressure separator to isolate the low pressure separator from the extruder 102. In this case, this valve would be closed as well. Next, the low pressure separator 98 can be depressurized by opening the vent valve 116 in the vent stream 114. This depressurization step effectively removes gas from the low pressure separator 98. As with other vent valves and streams, this vent stream 114 can be configured to vent selectively to either atmosphere or flare.

Next, a low range pressure gauge like that shown in FIG. 2 can be placed in fluid communication with the low pressure separator 98 to allow accurate pressure reading. Then N₂ can be introduced to the low pressure separator 98 by unlocking and sliding the quick change blinds located in N₂ streams 118 and/or 121 to an open position, followed by locking the quick change blinds in the open position. In this manner, the low pressure separator 98 can be purged with N₂. It is to be understood that the quick change blinds could be replaced with other types of valves; however, the use of the quick change blinds advantageously reduces the time to required to purge with N₂.

After performing maintenance on the low pressure separator 98, the depressurization and N₂ purging steps can be repeated until a concentration of O₂ present in the low pressure separator 98 is less than about 10 volppm, such as less than 9, 8, 7, 6, or 5 volppm. The N₂ can be allowed to remain in the low pressure separator 98 after the final purging step so that the reactant gas such as ethylene does not need to be introduced to the low pressure separator 98 before start-up. These steps can be automated using a sequence control.

### Purge Compressor Shutdown Process

In one or more embodiments, shut down of the purge compressor 106 can be performed by closing the pair of in-line valves 108 in stream 104, the pair of in-line valves 132 in stream 131, and the pair of in-line valves 124 in stream 122. Here, the in-line valve pairs 108 and 124 are upstream lock-out valve pairs; and the in-line valve pair 132 is the downstream lock-out valve pair, with respect to the purge compressor 106. The bleeder valves 112, 136, and 128 can also be opened. Then the purge compressor 106 can be depressurized by opening the vent valve 140 in the vent stream 138. This depressurization step effectively removes gas from the purge compressor 106. As with other vent streams, this vent stream 138 can be configured to vent selectively to either flare or atmosphere.

Further, a low range pressure gauge like that shown in FIG. 2 can be placed in fluid communication with purge compressor 106 to allow accurate pressure reading. Then N₂ can be introduced to the purge compressor 106 by unlocking and sliding the quick change blind disposed in N₂ stream 120 to an open position, followed by locking the quick change blind in the open position. In this manner, the purge compressor 106 can be purged with N₂. It is to be understood that the quick change blind could be replaced with other types of valves; however, the use of the quick change blind advantageously reduces the time required to purge with N₂.

After performing maintenance on the purge compressor 106, the depressurization and N₂ purging steps can be repeated until a concentration of O₂ present in the purge compressor 106 is less than about 10 volppm, such as less than 9, 8, 7, 6, or 5 volppm. The N₂ can be allowed to remain in the purge compressor 106 after the final purging step so that the reactant gas such as ethylene does not need to be introduced to the purge compressor 106 before start-up. These steps can be automated using a sequence control.

The foregoing shutdown processes were described in the context of N₂ purge to clear any remaining oxygen or atmospheric content in the sub-systems/reactor components after shutdown is completed and before bringing the respective reactor component back online, thereby ensuring that little or no oxygen is present in the reactor component at that time. in these and other embodiments, furthermore, a similar N₂ purge can be employed at the beginning of a shutdown process (e.g., before maintenance on the reactor component(s) begins) to purge any remnant ethylene and/or other remnant material from the normal reaction process from the reactor component. In this case, it is preferred to vent to flare (e.g., through the bleeder valve or other exit valve) rather than to atmosphere so as to avoid expelling ethylene or other reaction material into the atmosphere.

### Cooling Recycle System Cleaning Process

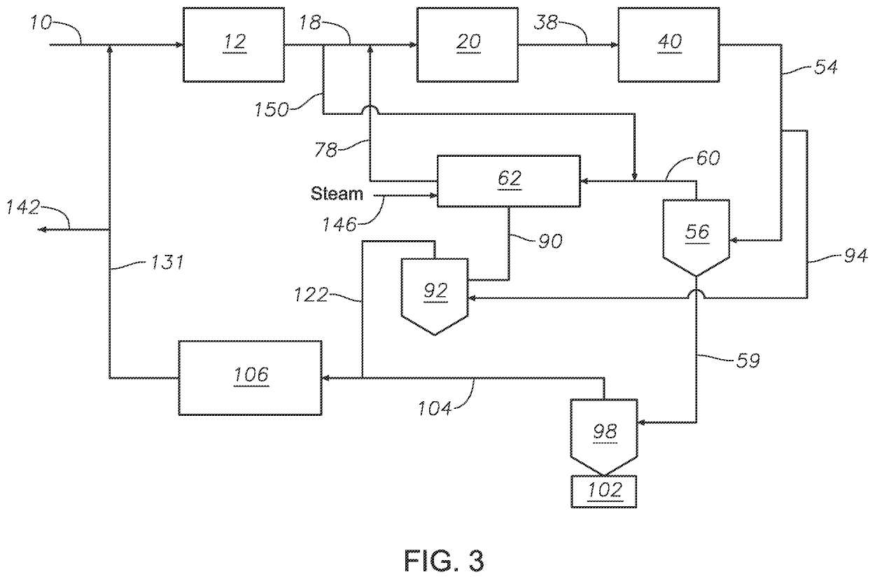

A flow diagram of an illustrative LDPE production process similar to the one depicted in FIG. 1 is shown in FIG. 3. All of the streams and sub-systems from FIG. 1 are the same with a few exceptions. For example, a portion of the gas stream 131 exiting the purge compressor 106 can also be sent to purification via stream 142 as shown. Also, steam or hot water can be introduced to the heat exchangers of the cooling recycle system 62 during cleaning, as indicated by stream 146. The steam or hot water can replace the cooling medium flowing through the cooling recycle system 62, which is typically water that is cooler than the unreacted gas flowing through the system 62. Another exception is that a bypass stream 150 can be connected to the compressed gas stream 18 on one end and to the unreacted gas stream 60 entering the cooling recycle system 62 on the other end. The bypass stream 150 can allow reactant gas to flow directly from the primary compressor 12 to the cooling recycle system 62, thereby bypassing the secondary compressor 20. Thus, cleaning of the cooling recycle system 62 can be performed concurrently with the shutdown of the secondary compressor 62. In addition, the bypass stream 150 allows gas recovery from the reactor 40 and the secondary compressor 20 to the cooling recycle system 62 to limit loss of ethylene and emissions associated with system depressurization.

Due to fouling of the heat exchangers of the cooling recycle system 62 that occurs over time, periodic cleaning of these heat exchanges is needed. Such fouling can be caused by the build-up of wax (e.g., LDPE) that separates out of the unreacted gas in the cooling recycle system 62 and becomes deposited on the heat exchanger parts. The process for cleaning or de-s fouling the cooling recycle system 62 can first entail closing a valve disposed in the outlet stream 78 of the cooling recycle system 62, followed by introducing steam or hot water to the cooling recycle system 62 via stream 146 to heat the wax. Replacing the recycle system cooling medium with a higher temperature medium such as steam or hot water allows for more effective removal (by melting) of the waxes. These waxes are subsequently drained into the collection vessel 92 via stream 90. The bypass stream 150 can also be employed to re-direct reactant material flowing to the secondary compressor 20 to the cooling recycle system 62 instead. By closing a valve disposed in the outlet stream 78, the wax entrained in the reactant material can be removed before it is recycled to the feed stream 18, resulting in less fouling of the secondary compressor 20. As previously disclosed, this cleaning of the cooling recycle system 62 can is occur concurrently with the shutdown of the secondary compressor 20.

### Other Cleaning Processes

The shutdown time required to clean the different sub-systems of the LDPE production process can further be reduced by using more effective cleaning techniques. The nature of the fouling and the equipment or piping lay-out and dimensions can affect the choice zo of which cleaning technique to use.

One such cleaning technique is known as “pigging”. During pigging, an object can be inserted in a pipe or in equipment that needs to be cleaned. The object can be used to scrape off unwanted material deposited in the pipe or equipment, and fluid at a relatively high pressure, e.g., about 800 bar to about 2,000 bar, can be used to push the unwanted material out of the pipe or equipment.

Another suitable cleaning technique is known as “aquadrilling”. In aquadrilling, a water blaster that whips around in a circle substantially equal to the inner diameter of a pipe can be used to apply water at a force sufficient to remove unwanted material from the pipe. The water blaster can be shaped, for example, like a rotating fan. Different types of heads can be used on the end of the water blaster that vary in hardness, shape, and size. The type of head that is used can be selected based on the type of fouling that is being removed.

Yet another suitable cleaning technique is known as “hydro-blasting”. Hydro-blasting can be employed to clean both the internal and external surfaces of pipes or equipment. During hydro-blasting, the sheer force of a fluid, such as water, applied at a relatively high pressure, e.g., at about 800 bar to about 2,000 bar, can be used to clean a surface.

Still another suitable cleaning technique is known as “hydrokinetic cleaning”. This technique can first involve isolating the section of the fouled pipe or equipment that needs to be cleaned. The isolated section can then be filled with fluid such as water, followed by introducing a sonic pulse to the fluid stream. As the pulse travels through the stream, the unwanted materials within the pipe or equipment resonate at different frequencies due to their different compositions. This variation in frequencies can result in breaking of the adhesive bond between the pipe/equipment and the foulant.

### Listing of Embodiments

This disclosure may further include any one or more of the following non-limiting embodiments:

1. A process for shutting down a reactor component in a LDPE production process, comprising: closing one or more pairs of upstream lock-out valves, each pair of upstream lock-is out valves being located in an inlet stream upstream of the reactor component and configured to cease fluid flow into the reactor component through said inlet stream when said pair of upstream lock-out valves is closed; closing one or more pairs of downstream lock-out valves, each pair of downstream lock-out valves being located in an outlet stream downstream of the reactor component and configured to cease fluid flow out of the reactor component through said outlet stream when said pair of downstream lock-out valves is closed; depressurizing the reactor component to a pressure greater than about 0 MPag and less than about 1.0 MPag; introducing purge gas comprising N₂ into the reactor component through a purge gas inlet at a pressure greater than about 0.5 MPag and less than about 5.0 MPag; and withdrawing the purge gas from the reactor component through a purge gas outlet, wherein withdrawing the purge gas comprises depressurizing the reactor component to a pressure greater than about 0 MPag and less than about 1.0 MPag.

2. The process according to embodiment 1, wherein the reactor component is a primary compressor, and further wherein the process comprises closing one pair of upstream lock-out valves and closing one pair of downstream lock-out valves.

3. The process according to embodiment 1 or 2, wherein the reactor component is a secondary compressor, and further wherein the process comprises closing two pairs of upstream lock-out valves and closing one pair of downstream lock-out valves.

4. The process according to any embodiment 1 to 3, wherein the reactor component is a reactor, and further wherein the process comprises closing one pair of upstream lock-out valves and closing one pair of downstream lock-out valves.

5. The process according to any embodiment 1 to 4, wherein the reactor component is a high pressure separator, and further wherein the process comprises closing one pair of upstream lock-out valves and closing two pairs of downstream lock-out valves.

6. The process according to any embodiment 1 to 5, wherein the reactor component is a cooling recycle system, and further wherein the process comprises closing one pair of upstream lock-out valves and closing two pairs of downstream lock-out valves.

7. The process according to any embodiment 1 to 6, wherein the reactor component is a low pressure separator, and further wherein the process comprises closing one pair of upstream lock-out valves and closing one pair of downstream lock-out valves.

8. The process according to any embodiment 1 to 7, wherein the reactor component is a collection vessel, and further wherein the process comprises closing two pairs of upstream lock-out valves and closing one pair of downstream lock-out valves.

9. The process according to any embodiment 1 to 8, wherein the reactor component is a purge compressor, and further wherein the process comprises closing two pairs of upstream lock-out valves and closing one pair of downstream lock-out valves.

10. The process according to any embodiment 1 to 9, wherein an upstream bleeder valve is located between each upstream lock-out valve within said each pair of upstream lock-out valves, wherein a downstream bleeder valve is located between each downstream lock-out valve within said each pair of downstream lock-out valves, and wherein each upstream bleeder valve and each downstream bleeder valve is opened when the corresponding pair of upstream lock-out valves and the corresponding pair of downstream lock-out valves are closed.

11. The process according to any embodiment 1 to 10, wherein said introducing the purge gas comprises sliding a quick change blind disposed in the purge gas inlet to an open position to allow the purge gas to pass through the quick change blind.

12. The process of according to any embodiment 1 to 11, wherein a low range pressure gauge is positioned in fluid communication with the reactor component being shut down to allow the reactor component to be depressurized to a pressure greater than about 0 MPag and less than about 1.0 MPag to reduce the number of depressurization/purge cycles required to obtain a concentration of O₂ present in the reactor component of less than about 10 volppm.

13. The process according to any embodiment 1 to 12, comprising purging multiple reactor components in series with N₂ by closing each pair of upstream lock-out valves located upstream of the upstream-most component being purged, closing each pair of downstream lock-out valves located downstream of the downstream-most component being purged, and leaving open all pairs of lock-out valves located between the upstream most component being purged and the downstream most component being purged.

14. The process according to any embodiment 1 to 13, further comprising cleaning a cooling recycle system of the LDPE production process, said cleaning comprising: closing a valve disposed in an outlet stream of a cooling recycle system, the outlet stream being recycled to an inlet stream of a secondary compressor, wherein the secondary compressor is downstream from a primary compressor and upstream from a reactor; introducing steam or hot water to the cooling recycle system; and introducing a bypass stream to an inlet stream of the cooling recycle system, wherein the bypass stream is connected to the inlet stream of the secondary compressor, thereby directing a reactant material from the primary compressor to the cooling is recycle system.

15. The process according to any embodiment 1 to 14, further comprising introducing recovered gas to a cooling recycle system of the LDPE production process, said introducing the recovered gas comprising: directing reactant material from a reactor to a wax collection vessel and subsequently through a purge compressor to a primary compressor, wherein the primary compressor is downstream from a secondary compressor that is upstream from the reactor; and introducing a bypass stream to an inlet stream of the cooling recycle system, wherein the bypass stream is connected to the inlet stream of the secondary compressor, thereby directing a reactant material from the primary compressor to the cooling recycle system.

16. A process for shutting down a reactor and a collection vessel in a LDPE production process, comprising: closing a first pair of in-line valves in a first stream being introduced to a reactor, a second pair of in-line valves in a second stream disposed between a cooling recycle system and a collection vessel for collecting wax, and a third pair of in-line valves in a third stream exiting the collection vessel, wherein a fourth stream exits the reactor and enters a high pressure separator disposed upstream from the cooling recycle system, wherein a first in-line valve and a second in-line valve downstream from the first in-line valve are disposed in the fourth stream, and wherein a fifth stream connects the fourth stream between the first in-line valve and the second in-line valve to the collection vessel; closing the second in-line valve in the fourth stream; opening a first bleeder valve in a first bleeder stream that connects to the first stream between the first pair of in-line valves, a second bleeder valve in a second bleeder stream that connects to the second stream between the second pair of in-line valves, a third bleeder valve in a third bleeder stream that connects to the third stream between the third pair of in-line valves, and a purge valve in the fifth stream; depressurizing the reactor to a pressure greater than about 0 MPag and less than about 1.0 MPag; and introducing purge gas comprising N₂ at a pressure greater than about 0.5 MPag and less than about 5.0 MPag to the reactor.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A process for shutting down a reactor component in a LDPE production process, comprising:
closing one or more pairs of upstream lock-out valves, each pair of upstream lock-out valves being located in an inlet stream upstream of the reactor component and configured to cease fluid flow into the reactor component through said inlet stream when said pair of upstream lock-out valves is closed;
closing one or more pairs of downstream lock-out valves, each pair of downstream lock-out valves being located in an outlet stream downstream of the reactor component and configured to cease fluid flow out of the reactor component through said outlet stream when said pair of downstream lock-out valves is closed;
depressurizing the reactor component to a pressure greater than about 0 MPag and less than about 1.0 MPag;
introducing purge gas comprising N₂ into the reactor component through a purge gas inlet at a pressure greater than about 0.5 MPag and less than about 5.0 MPag; and
withdrawing the purge gas from the reactor component through a purge gas outlet,
wherein withdrawing the purge gas comprises depressurizing the reactor component to a pressure greater than about 0 MPag and less than about 1.0 MPag.

2. The process of claim 1, comprising purging multiple reactor components in series with N₂ by closing each pair of upstream lock-out valves located upstream of the upstream-most component being purged, closing each pair of downstream lock-out valves located downstream of the downstream-most component being purged, and leaving open all pairs of lock-out valves located between the upstream-most component being purged and the downstream-most component being purged.

3. The process of claim 1, wherein the reactor component is a primary compressor, and further wherein the process comprises closing one pair of upstream lock-out valves and closing one pair of downstream lock-out valves.

4. The process of claim 1, wherein the reactor component is a secondary compressor, and further wherein the process comprises closing two pairs of upstream lock-out valves and closing one pair of downstream lock-out valves.

5. The process of claim 1, wherein the reactor component is a reactor, and further wherein the process comprises closing one pair of upstream lock-out valves and closing one pair of downstream lock-out valves.

6. The process of claim 1, wherein the reactor component is a high pressure separator, and further wherein the process comprises closing one pair of upstream lock-out valves and closing two pairs of downstream lock-out valves.

7. The process of claim 1, wherein the reactor component is a cooling recycle system, and further wherein the process comprises closing one pair of upstream lock-out valves and closing two pairs of downstream lock-out valves.

8. The process of claim 1, wherein the reactor component is a low pressure separator, and further wherein the process comprises closing one pair of upstream lock-out valves and closing one pair of downstream lock-out valves.

9. The process of claim 1, wherein the reactor component is a collection vessel, and further wherein the process comprises closing two pairs of upstream lock-out valves and closing one pair of downstream lock-out valves.

10. The process of claim 1, wherein the reactor component is a purge compressor, and further wherein the process comprises closing two pairs of upstream lock-out valves and closing one pair of downstream lock-out valves.

11. The process of claim 1, wherein an upstream bleeder valve is located between each upstream lock-out valve within said each pair of upstream lock-out valves, wherein a downstream bleeder valve is located between each downstream lock-out valve within said each pair of downstream lock-out valves, and wherein each upstream bleeder valve and each downstream bleeder valve is opened when the corresponding pair of upstream lock-out valves and the corresponding pair of downstream lock-out valves are closed.

12. The process of claim 1, wherein said introducing the purge gas comprises sliding a quick change blind disposed in the purge gas inlet to an open position to allow the purge gas to pass through the quick change blind.

13. The process of claim 1, wherein a low range pressure gauge is positioned in fluid communication with each reactor component being shut down to allow the reactor component to be depressurized to a pressure greater than about 0 MPag and less than about 1.0 MPag to reduce the number of depressurization/purge cycles required to obtain a concentration of O₂ present in the reactor component of less than about 10 volppm.

14. The process of claim 1, further comprising cleaning a cooling recycle system of the LDPE production process, said cleaning comprising:
closing a valve disposed in an outlet stream of a cooling recycle system, the outlet stream being recycled to an inlet stream of a secondary compressor, wherein the secondary compressor is downstream from a primary compressor and upstream from a reactor;
introducing steam or hot water to the cooling recycle system; and
introducing a bypass stream to an inlet stream of the cooling recycle system, wherein the bypass stream is connected to the inlet stream of the secondary compressor, thereby directing a reactant material from the primary compressor to the cooling recycle system.

15. The process of claim 1, further comprising introducing recovered gas to a cooling recycle system of the LDPE production process, said introducing the recovered gas comprising:
directing reactant material from a reactor to a wax collection vessel and subsequently through a purge compressor to a primary compressor, wherein the primary compressor is downstream from a secondary compressor that is upstream from the reactor;
introducing a bypass stream to an inlet stream of the cooling recycle system, wherein the bypass stream is connected to the inlet stream of the secondary compressor, thereby directing a reactant material from the primary compressor to the cooling recycle system.

16. A process for shutting down a reactor and a collection vessel in a LDPE production process, comprising:
closing a first pair of in-line valves in a first stream being introduced to a reactor, a second pair of in-line valves in a second stream disposed between a cooling recycle system and a collection vessel for collecting wax, and a third pair of in-line valves in a third stream exiting the collection vessel, wherein a fourth stream exits the reactor and enters a high pressure separator disposed upstream from the cooling recycle system, wherein a first in-line valve and a second in-line valve downstream from the first in-line valve are disposed in the fourth stream, and wherein a fifth stream connects the fourth stream between the first in-line valve and the second in-line valve to the collection vessel;
closing the second in-line valve in the fourth stream;
opening a first bleeder valve in a first bleeder stream that connects to the first stream between the first pair of in-line valves, a second bleeder valve in a second bleeder stream that connects to the second stream between the second pair of in-line valves, a third bleeder valve in a third bleeder stream that connects to the third stream between the third pair of in-line valves, and a purge valve in the fifth stream;
depressurizing the reactor to a pressure greater than about 0 MPag and less than about 1.0 MPag; and
introducing purge gas comprising N₂ at a pressure greater than about 0.5 MPag and less than about 5.0 MPag to the reactor.
